(19) United States
(12) Patent Application Publication
(10) Pub. No.: US 2023/0279704 A1
(43) Pub. Date: Sep. 7, 2023

(54) Security Tube Assembly

(71) Applicant: George Shankool, Phoenix, AZ (US)

(72) Inventor: George Shankool, Phoenix, AZ (US)

(21) Appl. No.: 17/684,942

(22) Filed: Mar. 2, 2022

(51) Int. Cl. E05C 19/00

(52) U.S. Cl. CPC E05C 19/005

(57) ABSTRACT

A security tube assembly for securing a door in a closed position includes a mounting plate that is mountable to a wall at a point located adjacent to a door in the wall. A bracket is mountable to the wall on an opposite side of the door with respect to the mounting plate. A tube is pivotally coupled to the mounting plate. The tube is positionable in first position having the tube extending downwardly alongside the door to facilitate the door to be opened or closed. Conversely, the tube is positionable in a second position having the tube extending across the door and having the tube resting in the bracket to inhibit the door from opening.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to security devices and more particularly pertains to a new security device for securing a door in a closed position. The device includes a mounting plate that is mountable next to a door and a tube that is pivotally attached to the mounting plate. The device includes a bracket that is mountable next to the door on an opposite side of the door from the mounting plate. The tube is positionable in a first position having the tube extending downwardly along the door for opening or closing the door. The tube is positionable in a second position having the tube extending across the door to inhibit the door from being opened.

### (2) Description of Related Art Including Information Disclosed Under 37 CFR 1.97 and 1.98

The prior art relates to security devices including a door securing bar that includes a pivoting hinge on one end of a bar which extends across a door and a latch with engages the bar. The prior art discloses a bar with a telescopic length that is mountable to extend laterally across a door. The prior art discloses a door locking bar which includes a first portion of a bar which has a first portion that is pivotally coupled to a second portion having the first portion extending laterally across a door and having the second portion engaging a lock. The prior art discloses a door security device that includes a bar which extends across a door, a locking mechanism attached to the door which releasably engages the bar and a clasp which engages the bar. The prior art discloses a door locking bar which includes a pair of clasps that are positioned on opposite sides of a door and a bar that is positioned to extend between the clasps for securing the door. The prior art discloses a door locking device which includes a tube having a telescopic length, a biasing member positioned within the tube and a lock integrated into the tube.

### BRIEF SUMMARY OF THE INVENTION

An embodiment of the disclosure meets the needs presented above by generally comprising a mounting plate that is mountable to a wall at a point located adjacent to a door in the wall. A bracket is mountable to the wall on an opposite side of the door with respect to the mounting plate. A tube is pivotally coupled to the mounting plate. The tube is positionable in first position having the tube extending downwardly alongside the door to facilitate the door to be opened or closed. Conversely, the tube is positionable in a second position having the tube extending across the door and having the tube resting in the bracket to inhibit the door from opening.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a security tube assembly according to an embodiment of the disclosure.

FIG. 2 is a perspective view of a bracket of an embodiment of the disclosure.

FIG. 3 is a perspective view of a mounting plate of an embodiment of the disclosure.

FIG. 4 is an exploded perspective view of a tube, a mounting plate and a bolt of an embodiment of the disclosure.

FIG. 5 is a perspective in-use view of an embodiment of the disclosure showing a tube in a second position.

FIG. 6 is a detail view taken from square 6 of FIG. 5 of an embodiment of the disclosure.

FIG. 7 is a detail view taken from square 7 of FIG. 5 of an embodiment of the disclosure.

FIG. 8 is a perspective in-use view of an embodiment of the disclosure showing a tube in a first position.

### DETAILED DESCRIPTION OF THE INVENTION

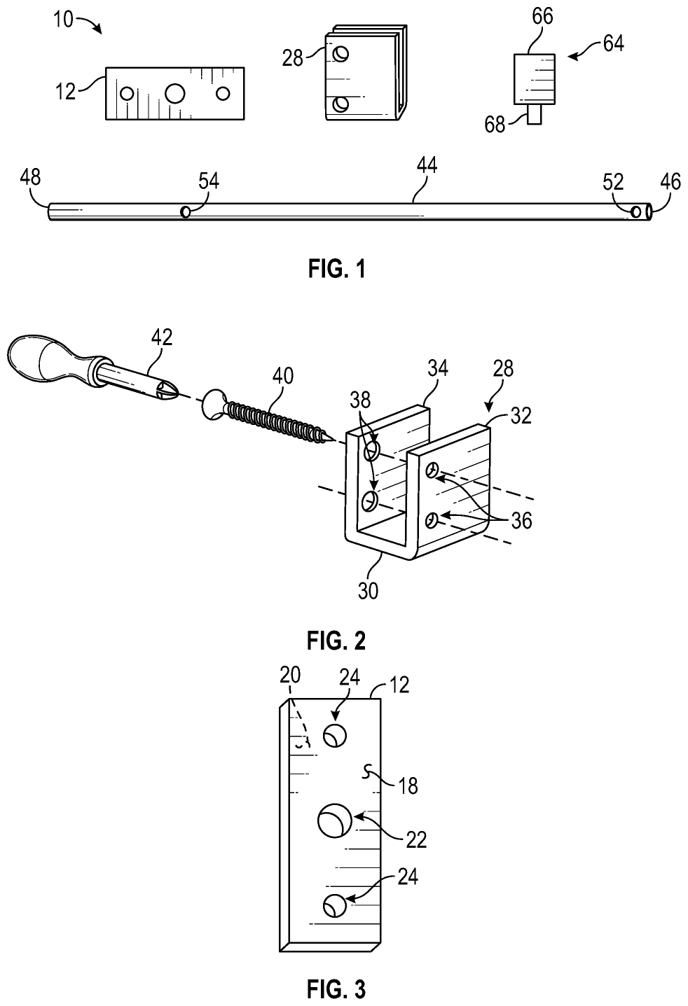

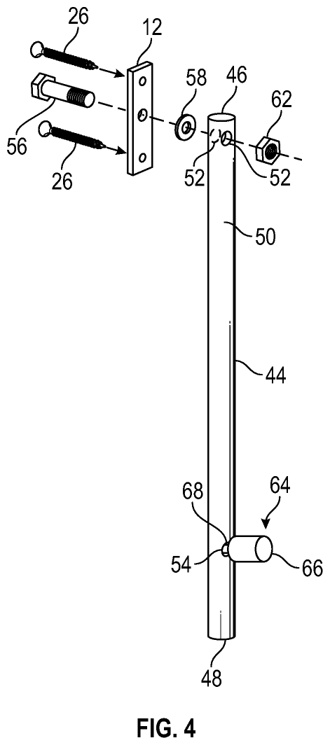

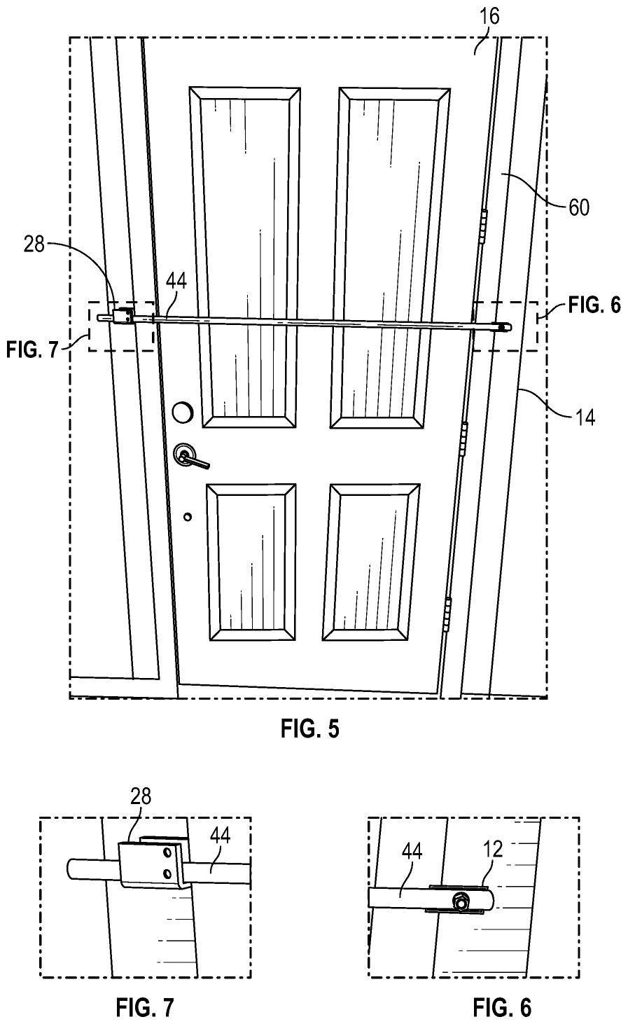

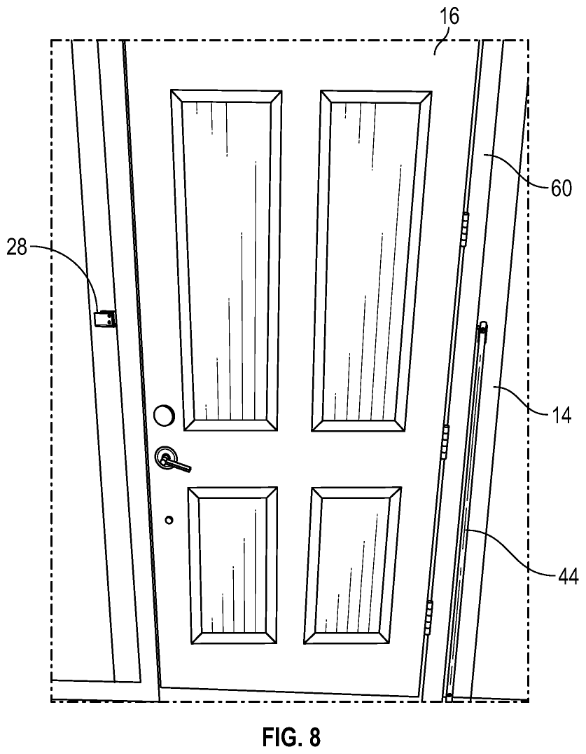

With reference now to the drawings, and in particular to FIGS. 1 through 8 thereof, a new security device embodying the principles and concepts of an embodiment of the disclosure and generally designated by the reference numeral 10 will be described.

As best illustrated in FIGS. 1 through 8, the security tube assembly 10 generally comprises a mounting plate 12 that is mountable to a wall 14 a point located adjacent to a door 16 in the wall 14. The wall 14 may be a wall of a building and the door 16 may be a man door. The mounting plate 12 has a first surface 18 and a second surface 20, and the mounting plate 12 has a first hole 22 extending through the first surface 18 and the second surface 20. Additionally, the first hole 22 is centrally positioned on the mounting plate 12.

The mounting plate 12 has a pair of second holes 24 each extending through the first surface 18 and the second surface 20. Each of the second holes 24 is positioned on opposite sides of the first hole 22 with respect to each other. The first hole 22 has a diameter that is greater than a diameter of each of the second holes 24, and each of the second holes 24 has an equal diameter with respect to each other. Each of the second holes 24 insertably receives a fastener 26, such as a screw of other penetrating fastener, which engages the wall 14 for mounting the mounting plate 12 to the wall 14. The first hole 22 may have a diameter of approximately 0.375 inches and each of the second holes 24 may have a diameter of approximately 0.25 inches.

A bracket 28 is provided which is mountable to the wall 14 at a point located adjacent to the door 16. The bracket 28 is positioned on an opposite side of the door 16 with respect to the mounting plate 12. The bracket 28 has a central portion 30 extending between a first outward portion 32 and a second outward portion 34. Each of the first outward portion 32 and the second outward portion 34 is perpendicularly oriented with the central portion 30 such that the bracket 28 has a U-shape. The bracket 28 has a pair of first apertures 36 each extending through the first outward portion 32 and the bracket 28 has a pair of second apertures 38 each extending through the second outward portion 34. Each of the second apertures 38 is aligned with a respective one of the first apertures 36.

Each of the first apertures 36 insertably receives a fastener 40 which engages the wall 14 for mounting the bracket 28 to the wall 14 has the first outward portion 32 abutting the wall 14. Each of the second apertures 38 has a diameter that is greater than a diameter of the first apertures 36. In this way each of the second apertures 38 can accommodate a tool 42, such as a screwdriver or the like, for tightening or loosening the fasteners 40 which extend through the first apertures 36. Furthermore, the bracket 28 is oriented on the wall 14 having each of the first outward portion 32 and the second outward portion 34 being vertically oriented and having the central portion 30 being horizontally oriented. Each of the first apertures 36 may have a diameter of approximately 0.25 inches and each of the second apertures 38 may have a diameter of approximately 0.375 inches.

A tube 44 is provided which is pivotally coupled to the mounting plate 12. The tube 44 is positionable in first position having the tube 44 extending downwardly alongside the door 16 to facilitate the door 16 to be opened or closed. Conversely, the tube 44 is positionable in a second position having the tube 44 extending across the door 16 and having the tube 44 resting in the bracket 28. In this way the tube 44 inhibits the door 16 from opening. The tube 44 is comprised of a rigid material, such as steel of other metallic alloy. Furthermore, the tube 44 has a length that is greater than a width of the door 16.

The tube 44 has a first end 46, a second end 48 and an outer wall 50 extending between the first end 46 and the second end 48, and the tube 44 has a pair of first opening 52 each extending through the outer wall 50 of the tube 44. Each of the first opening 52 is positioned on opposite sides of the outer wall 14 of the tube 44 from each other and the first opening 52 are aligned with each other. Each of the first opening 52 is positioned adjacent to the first end 46. Continuing, the tube 44 has a second opening 54 extending through the outer wall 50 of the tube 44 and the second opening 54 is positioned adjacent to the second end 48.

A bolt 56 is provided which extends through each of the first opening 52 in the outer wall 50 of the tube 44 and engages the first hole 22 in the mounting plate 12 for pivotally attaching the tube 44 to the mounting plate 12. A spacer 58 is positionable around the bolt 56 and the spacer 58 is positioned between the tube 44 and the mounting plate 12 for spacing the tube 44 a selected distance from the mounting plate 12. In this way the spacer 58 facilitates the tube 44 to accommodate trim 60 around the door 16. The bolt 56 may include a nut 62 for securing the tube 44 to the bolt 56.

A stopper 64 is provided which comprises a plug 66 and a stem 68 extending away from the plug 66. The stem 68 engages the second opening 54 in the tube 44 such that the plug 66 is perpendicularly oriented with the tube 44. The plug 66 is comprised of a resiliently compressible material such as rubber or other similar material. Furthermore, the plug 66 abuts the door 16 when the tube 44 is positioned in the second position thereby restraining the door 16 when the tube 44 is positioned in the bracket 28. The stem 68 may be threaded to facilitate the stem 68 to threadably engage the second opening 54 in the tube 44.

In use, the bolt 56 is extended through said first hole 22 in the mounting plate 12 and each of the first opening 52 in the outer wall 14 of the tube 44 and the mounting plate 12 is fastened to the wall 14. The bracket 28 is fastened to the wall 14 on the opposite side of the door 16 from the mounting plate 12. Additionally, the spacer 58 may be positioned around the bolt 56 to facilitate the tube 44 to clear trim around the door 16, if necessary. The tube 44 is positioned in the second position such that the tube 44 is positioned in the bracket 28 to inhibit the door 16 from being opened. In this way a child, for example, is inhibited from opening the door 16. Furthermore, the tube 44 inhibits the door 16 from being forcibly opened by an intruder, for example. The tube 44 is positioned in the first position to facilitate the door 16 to be opened or closed.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A security tube assembly for inhibiting a door from being opened, said assembly comprising:
a mounting plate being mountable to a wall a point located adjacent to a door in the wall;
a bracket being mountable to the wall at a point located adjacent to the door, said bracket being positioned on an opposite side of the door with respect to said mounting plate; and
a tube being pivotally coupled to said mounting plate, said tube being positionable in first position having said tube extending downwardly alongside the door wherein said tube is configured to facilitate the door to be opened or closed, said tube being positionable in a second position having said tube extending across the door and having said tube resting in said bracket wherein said tube is configured to inhibit the door from opening.

2. The assembly according to claim 1, wherein:
said mounting plate has a first surface and a second surface;
said mounting plate has a first hole extending through said first surface and said second surface, said first hole being centrally positioned on said mounting plate;
said mounting plate has a pair of second holes each extending through said first surface and said second surface;
each of said second holes is positioned on opposite sides of said first hole with respect to each other;
said first hole has a diameter being greater than a diameter of each of said second holes;
each of said second holes has an equal diameter with respect to each other; and
each of said second holes insertably receiving a fastener which engages the wall for mounting said mounting plate to the wall.

3. The assembly according to claim 1, wherein:
said bracket has a central portion extending between a first outward portion and a second outward portion, each of said first outward portion and said second outward portion being perpendicularly oriented with said central portion such that said bracket has a U-shape;
said bracket has a pair of first apertures each extending through said first outward portion; and
said bracket has a pair of second apertures each extending through said second outward portion.

4. The assembly according to claim 3, wherein each of said second apertures is aligned with a respective one of said first apertures, each of said first apertures insertably receiving a fastener which engages the wall for mounting said bracket to the wall having said first outward portion abutting the wall.

5. The assembly according to claim 4, wherein each of said second apertures has a diameter being greater than said first apertures wherein each of said second apertures is configured to accommodate a tool for tightening or loosening the fasteners which extend through said first apertures.

6. The assembly according to claim 3, wherein said bracket is oriented on the wall having each of said first outward portion and said second outward portion being vertically oriented and having said central portion being horizontally oriented.

7. The assembly according to claim 1, wherein:
said tube has a first end, a second end and an outer wall extending between said first end and said second end;
said tube has a pair of first openings each extending through said outer wall, each of said first openings being positioned on opposite sides of said outer wall from each other, said first openings being aligned with each other, each of said first openings being positioned adjacent to said first end;
said tube has a second opening extending through said outer wall, said second opening being positioned adjacent to said second end.

8. The assembly according to claim 7, wherein:
said mounting plate has a first surface and a second surface;
said mounting plate has a first hole extending through said first surface and said second surface, said first hole being centrally positioned on said mounting plate; and
said assembly includes a bolt extending through each of said first openings in said outer wall of said tube and engaging said first hole in said mounting plate for pivotally attaching said tube to said mounting plate.

9. The assembly according to claim 8, further comprising a spacer being positionable around said bolt, said spacer being positioned between said tube and said mounting plate for spacing said tube a selected distance from said mounting plate wherein said spacer is configured to facilitate said tube to accommodate trim around the door.

10. The assembly according to claim 7, further comprising a stopper comprising a plug and a stem extending away from said plug, said stem engaging said second opening in said tube such that said plug is perpendicularly oriented with said tube.

11. The assembly according to claim 10, wherein said plug being comprised of a resiliently compressible material.

12. The assembly according to claim 10, wherein said plug abuts the door when said tube is positioned in said second position thereby restraining the door when said tube is positioned in said bracket.

13. A security tube assembly for inhibiting a door from being opened, said assembly comprising:
a mounting plate being mountable to a wall a point located adjacent to a door in the wall, said mounting plate having a first surface and a second surface, said mounting plate having a first hole extending through said first surface and said second surface, said first hole being centrally positioned on said mounting plate, said mounting plate having a pair of second holes each extending through said first surface and said second surface, each of said second holes being positioned on opposite sides of said first hole with respect to each other, said first hole having a diameter being greater than a diameter of each of said second holes, each of said second holes having an equal diameter with respect to each other, each of said second holes insertably receiving a fastener which engages the wall for mounting said mounting plate to the wall;
a bracket being mountable to the wall at a point located adjacent to the door, said bracket being positioned on an opposite side of the door with respect to said mounting plate, said bracket having a central portion extending between a first outward portion and a second outward portion, each of said first outward portion and said second outward portion being perpendicularly oriented with said central portion such that said bracket has a U-shape, said bracket having a pair of first apertures each extending through said first outward portion, said bracket having a pair of second apertures each extending through said second outward portion, each of said second apertures being aligned with a respective one of said first apertures, each of said first apertures insertably receiving a fastener which engages the wall for mounting said bracket to the wall having said first outward portion abutting the wall, each of said second apertures having a diameter being greater than said first apertures wherein each of said second apertures is configured to accommodate a tool for tightening or loosening the fasteners which extend through said first apertures, said bracket being oriented on the wall having each of said first outward portion and said second outward portion being vertically oriented and having said central portion being horizontally oriented;
a tube being pivotally coupled to said mounting plate, said tube being positionable in first position having said tube extending downwardly alongside the door wherein said tube is configured to facilitate the door to be opened or closed, said tube being positionable in a second position having said tube extending across the door and having said tube resting in said bracket wherein said tube is configured to inhibit the door from opening, said tube having a first end, a second end and an outer wall extending between said first end and said second end, said tube having a pair of first openings each extending through said outer wall of said tube, each of said first openings being positioned on opposite sides of said outer wall of said tube from each other, said first openings being aligned with each other, each of said first openings being positioned adjacent to said first end, said tube having a second opening extending through said outer wall of said tube, said second opening being positioned adjacent to said second end;
a bolt extending through each of said first openings in said outer wall of said tube and engaging said first hole in said mounting plate for pivotally attaching said tube to said mounting plate;
a spacer being positionable around said bolt, said spacer being positioned between said tube and said mounting plate for spacing said tube a selected distance from said mounting plate wherein said spacer is configured to facilitate said tube to accommodate trim around the door; and
a stopper comprising a plug and a stem extending away from said plug, said stem engaging said second opening in said tube such that said plug is perpendicularly oriented with said tube, said plug being comprised of a resiliently compressible material, said plug abutting the door when said tube is positioned in said second position thereby restraining the door when said tube is positioned in said bracket.

14. A security tube system for inhibiting a door from being opened, said system comprising:
a door being hingedly integrated into a wall;
a mounting plate being mountable to said wall a point located adjacent to said door, said mounting plate having a first surface and a second surface, said mounting plate having a first hole extending through said first surface and said second surface, said first hole being centrally positioned on said mounting plate, said mounting plate having a pair of second holes each extending through said first surface and said second surface, each of said second holes being positioned on opposite sides of said first hole with respect to each other, said first hole having a diameter being greater than a diameter of each of said second holes, each of said second holes having an equal diameter with respect to each other, each of said second holes insertably receiving a fastener which engages said wall for mounting said mounting plate to said wall;
a bracket being mountable to said wall at a point located adjacent to said door, said bracket being positioned on an opposite side of said door with respect to said mounting plate, said bracket having a central portion extending between a first outward portion and a second outward portion, each of said first outward portion and said second outward portion being perpendicularly oriented with said central portion such that said bracket has a U-shape, said bracket having a pair of first apertures each extending through said first outward portion, said bracket having a pair of second apertures each extending through said second outward portion, each of said second apertures being aligned with a respective one of said first apertures, each of said first apertures insertably receiving a fastener which engages said wall for mounting said bracket to said wall having said first outward portion abutting said wall, each of said second apertures having a diameter being greater than said first apertures wherein each of said second apertures is configured to accommodate a tool for tightening or loosening the fasteners which extend through said first apertures, said bracket being oriented on said wall having each of said first outward portion and said second outward portion being vertically oriented and having said central portion being horizontally oriented;
a tube being pivotally coupled to said mounting plate, said tube being positionable in first position having said tube extending downwardly alongside said door such that said tube facilitates said door to be opened or closed, said tube being positionable in a second position having said tube extending across said door and having said tube resting in said bracket to inhibit said door from opening, said tube having a first end, a second end and an outer wall extending between said first end and said second end, said tube having a pair of first openings each extending through said outer wall of said tube, each of said first openings being positioned on opposite sides of said outer wall of said tube from each other, said first openings being aligned with each other, each of said first openings being positioned adjacent to said first end, said tube having a second opening extending through said outer wall of said tube, said second opening being positioned adjacent to said second end;
a bolt extending through each of said first openings in said outer wall of said tube and engaging said first hole in said mounting plate for pivotally attaching said tube to said mounting plate;
a spacer being positionable around said bolt, said spacer being positioned between said tube and said mounting plate for spacing said tube a selected distance from said mounting plate to facilitate said tube to accommodate trim around said door; and
a stopper comprising a plug and a stem extending away from said plug, said stem engaging said second opening in said tube such that said plug is perpendicularly oriented with said tube, said plug being comprised of a resiliently compressible material, said plug abutting said door when said tube is positioned in said second position thereby restraining said door when said tube is positioned in said bracket.
